(19) United States
(12) Patent Application Publication
(10) Pub. No.: US 2022/0172040 A1
(43) Pub. Date: Jun. 2, 2022

(54) TRAINING A MACHINE-LEARNED MODEL BASED ON FEEDBACK

(71) Applicant: Microsoft Technology Licensing, LLC, Redmond, WA (US)

(72) Inventors: Michaeel M. KAZI, Foster City, CA (US); Weiwei GUO, Foster City, CA (US); Huiji GAO, Sunnyvale, CA (US); Bo LONG, Palo Alto, CA (US)

(21) Appl. No.: 17/107,560

(22) Filed: Nov. 30, 2020

(51) Int. Cl. G06N 3/08; G06N 3/04; G06F 16/242

(52) U.S. Cl. CPC G06N 3/08; G06F 16/2425; G06N 3/0445

(57) ABSTRACT

Techniques for training a machine-learned model based on feedback are provided. In one technique, reformulation data that comprises a plurality of sequence pairs is stored. Also, feedback data that comprises a plurality of sequence triples is stored. Based on the reformulation data and the feedback data, one or more machine learning techniques are used to train a sequence-to-sequence model. Training the sequence-to-sequence model involves using a loss function that comprises (1) a first term that takes, as input, sequence pairs from the reformulation data and (2) a second term that takes, as input, sequence triples from the feedback data. After training the sequence-to-sequence, a search query is received from a computing device. In response to receiving the search query, a set of embeddings is retrieved, each corresponding to a token in the search query. The set of embeddings is input into the sequence-to-sequence model, which generates one or more query suggestions. The one or more query suggestions are then presented on the computing device.

### TECHNICAL FIELD

The present disclosure generally relates to machine learning and, more particularly, to modifying a training process to incorporate user feedback.

### BACKGROUND

Modern electronic content platforms may host thousands or tens of thousands of electronic documents. Therefore, many electronic content platforms provide electronic search mechanisms that allow users to quickly search for electronic documents of interest, typically using one or more keywords. Sometimes, after an electronic search is performed based on a search query, a user is not satisfied with the search result, which may indicate that no results were identified or may include one or more results, none of which the user deems sufficiently relevant.

To address this issue, an electronic search mechanism may present alternate search queries that may yield relevant results to the user. Such alternate search queries are referred to as “related search queries.” Related search queries are search queries that (a) may have been entered by other users that have used the electronic search mechanism and/or (b) may be considered similar to the original search query that the user entered. Benefits of presenting one or more related search queries to a user include (1) the user not having to manually enter the related search query, which would risk entering in a misspelling, and (2) the user more quickly receiving relevant search results.

Limiting related search queries to actual search queries that previous users entered better ensures that the related search queries are well-formed and are more likely to make sense. However, a downside of this approach is that the number of such related search queries may be few and there may be many future search queries that have no similar antecedent. Also, none of the actual search queries may be related to a currently-entered search queries. To address these issues, an electronic search mechanism may automatically generate related search queries, some of which may have never been entered by users before. However, while this approach may be more versatile, there is the risk that such related search queries do not make sense and, thus, the quality of the related search queries are low. Consequently, the utility of this approach decreases.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for automatically generating query suggestions, in an embodiment;

FIG. 2 is a screenshot of an example user interface that is presented on a screen of a computing device, in an embodiment;

FIG. 3 is a block diagram that depicts an example query suggestion component, in an embodiment;

FIG. 4 is a block diagram that depicts an example sequence-to-sequence model, in an embodiment;

FIG. 5 is a flow diagram that depicts an example process for generating query suggestions using a sequence-to-sequence model, in an embodiment;

FIG. 6 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Training Data

One approach to collecting training data to train a machine-learned model that automatically outputs related (or “suggested”) search queries given an input search query is to track pairs of search queries that a user has entered. For example, a user enters (e.g., types) “software engineer” into a text field of a search interface and an electronic search mechanism generates a set of results and presents the set of results on a display of a computing device operated by the user. Instead of the user selecting a result in the set of results, the user enters “machine learning engineer” in place of “software engineer” because the user might not be satisfied with any of the results. The electronic search mechanism records both search queries and associates them together, tagging the first search query as the source search query and the second search query as the target search query. The target search query is considered a reformulation of the first or original search query. Each source-target search query pair is recorded and may be used to train a machine-learned model. One or more source-target search query pairs are collectively referred to herein as “reformulation data.”

Another source of training data is user feedback in the form of user selections (e.g., clicks) of related search queries that were automatically suggested (i.e., “query suggestions”) to users by the electronic search mechanism, or a related component. For example, a user enters “software engineer” into a text field of a search interface and an electronic search mechanism presents a set of search results and a set of query suggestions. The user then selects one of the query suggestions. The electronic search mechanism records the original search query, the query suggestion that the user selected, and the query suggestion(s) that was/were not selected by the user. Thus, the electronic search mechanism tags (1) the original search query as the source search query, (2) the selected (e.g., clicked) query suggestion as a positive query suggestion, and (3) each non-selected query suggestion as a negative query suggestion. Such a set of three queries is referred to as a “sequence triple.” The positive and negative query suggestions are considered user feedback. All generated sequence triples are considered user feedback data and may be used to train a machine-learned model.

### Incorporating User Feedback

One way to incorporate user feedback data into a machine learning model architecture is to train and use a post-ranking model that is separate from a main machine-learned (ML) model that is trained based on reformulation data and that generates a set of query suggestions given an input search query. The post-ranking model is trained to increase the recall of query suggestions that were actually selected (or clicked) by users. However, there are a number of drawbacks since this approach requires two separate models to be trained and deployed. Not only does having two separate models increase the complexity of the search ecosystem, it increases the time to produce a set of query suggestions.

Another way to incorporate user feedback into the ML model is to fine tune the ML model with the user feedback data. However, this approach may over focus on the user feedback data. With fine tuning, the ML model has a tendency to “forget” earlier information (i.e., the reformulation data). This can be mitigated by reducing the size of the user feedback data, but this would mean that the ML model incorporates less user feedback data and, as a result, the ML model will be closer to the baseline.

Another way to incorporate user feedback into the ML model is to train the ML model with a mixture of reformulation data and user feedback data. Thus, both sets of training data are treated together as a single set of training data. Because there may be many more training samples from the reformulation data than from the user feedback data, the ML model may be biased towards the reformulation data. Such bias may be addressed by oversampling the smaller dataset. However, the ML model still only uses positive training samples (and none of the negative training samples from the user feedback data is used), and the ML model is essentially trained to memorize both sets of data. There is no separate interpretation of the user feedback data.

### General Overview

A system and method for training a machine-learned (ML) model that generates query suggestions based on an input search query are provided. In an embodiment, only a single ML model is used to generate a set of query suggestions. An embodiment involves augmenting the loss function (that is used to train the ML model) in order to take into account different interpretations of different types of data: the reformulation data and the user feedback data. For example, the loss function is augmented with a pairwise-rank term that uses both positive and negative user feedback examples. This approach continues the training on the reformulation data and directly treats the user feedback data as ranking data. This is done because the absolute merit of query suggestions (particularly non-selected ones) is not known. Instead, which query suggestions are preferred is known through user selections of those query suggestions.

Embodiments improve computer-related technology; namely, search technology and, more particularly, query suggestion technology. One benefit of embodiments herein include training and deploying a single ML model, which is simpler and more robust than training and deploying two ML models, one for generating query suggestions and another for ranking the query suggestions based on user feedback. Another benefit of embodiments herein includes incorporating user feedback data not only in the same ML model, but using the same architecture, which does not require any changes in code for serving query suggestions. Thus, additional serving time latency is avoided while increasing accuracy in query suggestions by incorporating user feedback data in a novel way.

### System Overview

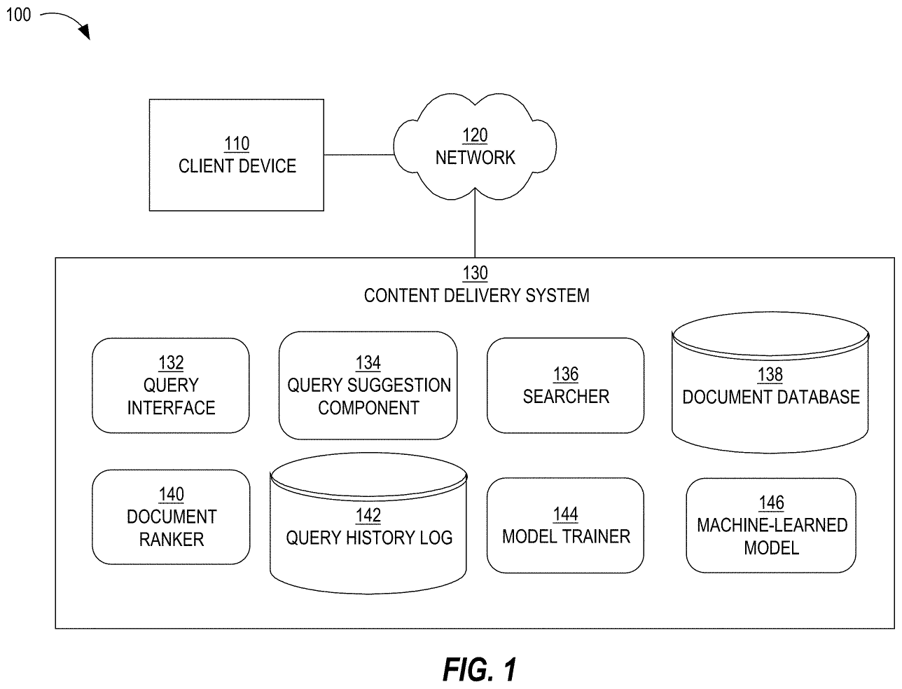

FIG. 1 is a block diagram that depicts an example system 100 for automatically generating query suggestions, in an embodiment. System 100 includes a client device 110, a network 120, and a content delivery system 130. Although only a single client device is depicted, multiple client devices may be communicatively coupled to content delivery system 130 through network 120 and/or other networks (not depicted). Content delivery system 130 comprises one or more computing elements that perform the operations described herein as being performed by content delivery system 130. Network 120 is a computer network, examples of which include a local area network (LAN), a wide area network (WAN), and the Internet.

Content delivery system 130 includes a query interface 132, a query suggestion component 134, a searcher 136, a document database 138, a document ranker 140, a query history log 142, a model trainer 144, and a machine-learned model 146.

Examples of client device 110 include a desktop computer, a laptop computer, a tablet computer, a wearable device, a video game console, and a smartphone. Client device 110 transmits input comprising one or more query terms over network 120 to content delivery system 130. The query terms may be entered through client device 110 through one or more ways.

For example, a user of client device 110 may select one or more characters on (a) a physical keyboard of client device 110 or (b) a graphical keyboard that is presented on a touchscreen display of client device 110. Such selection may occur while a keyboard cursor is within a particular text field of a user interface that is presented on a screen of client device 110. After each character is selected, the character is transmitted over network 120 to content delivery system 130. A client application executing on client device 110 transmits the character(s) to content delivery system 130. Examples of such a client application include (1) a web application that executes within a web browser that executes on client device 110 and (2) a native application that is installed on client device 110 and is configured to communicate with content delivery system 130. The transmission of the input may include only the most recently selected character or may include all characters that have been entered thus far in the particular text field or thus far during a user session.

As another example, a user of client device 110 speaks one or more characters or words and a microphone of client device 110 detects the audible input and generates digital voice data therefrom. After which, a client application executing on client device 110 transmits the digital voice data to content delivery system 130.

Content delivery system 130 receives the input through query interface 132. The input may comprise text data or voice data. If the input comprises text data, then the text data comprises one or more characters, such as alphanumeric characters. If the input comprises voice data, then query interface 132 (or another element of content platform) translates the voice data into one or more characters.

### Query Suggestion Component

Query suggestion component 134 generates one or more query suggestions based on the input received through query interface 132 and causes the one or more query suggestions to be transmitted over network 120 to be presented on a screen of client device 110. In response, a user may select one of the query suggestion(s) that is presented on the screen of client device 110. An indication of the selection is transmitted from client device 110 to content delivery system 130.

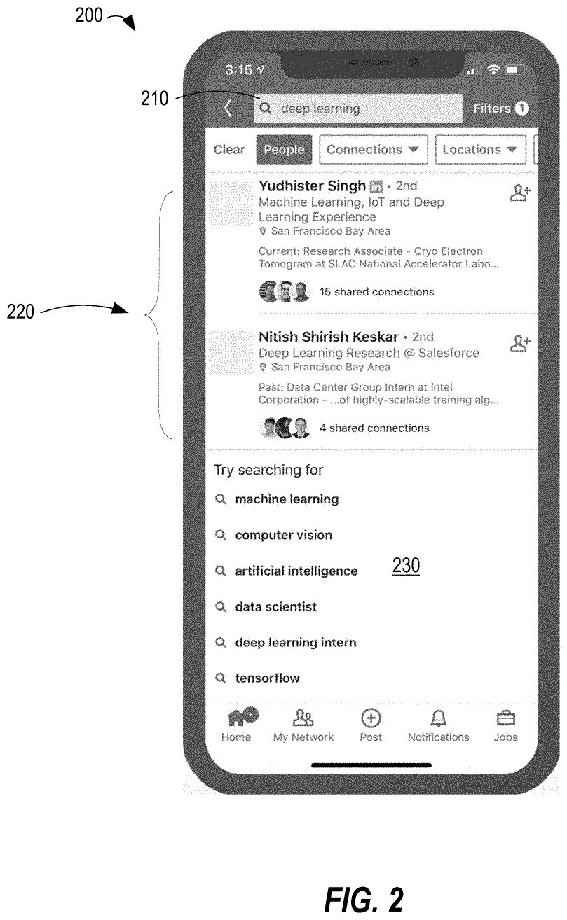

FIG. 2 is a screenshot of an example user interface 200 that is presented on a screen of a computing device, in an embodiment. User interface 200 includes one or more graphical elements for allowing a user to compose a search query. In this example, those one or more graphical elements includes a text field 210 that allows a user to enter text. Search results portion 220 of user interface 200 includes search results that are based on a search query, which is “deep learning” in this example. Search results portion 220 includes two search results, each including information from a user profile regarding a different user. The respective user profiles either include “deep learning” (such as in a skill section or a work history section of the user profile) or are otherwise semantically associated with “deep learning.” Because the search results correspond to user profiles, each search result also includes connection information that indicates a number of common connections between (1) the user operating the computing device that displays user interface 200 and (2) the user corresponding to the user profile.

User interface 200 also includes a query suggestion portion 230 that includes multiple query suggestions that are based on the input search query “deep learning.” If the user is not satisfied with the search results in portion 220, then the user may select one of the query suggestions, which initiates another search.

### Searcher

For each search query received from a client device, searcher 136 performs a search. The search query comprises one or more terms, where each term may be delineated by one or more characters, such as a space, a comma, a period, or an integer. The search query may be an original search query (i.e., that was composed at least partially by the user of the client device) or a query suggestion (determined by query suggestion component 134) that was presented to the user after the user entered an original search query and that the user selected. User selection of a query suggestion may be with a cursor control device that is communicatively coupled to a (e.g., laptop or desktop) computer. Alternatively, user selection of a query suggestion may be with a finger or stylus on a touchscreen display (e.g., of a smartphone or a tablet computer).

A partially-composed search query is one where the user entered one or characters and content delivery system 130 automatically determined one or more auto-completed search queries based on the entered character(s) and caused such queries to be presented to the user. Thus, content delivery system 130 did not receive any indication (such as the user selecting a graphical “Enter” button in a search interface or a physical “Enter” button on a keyboard) that the user was finished entering all the characters of the intended search query. The one or more characters that a user enters before content delivery system 130 receives such an indication is referred to as an “incomplete query.” For example, two characters that are input into a search interface by a user (i.e., an incomplete query) may result in content delivery system 130 presenting four auto-completed queries, each greater in length than the incomplete query.

Searcher 136 may search document database 138 using an index and terms of the search query. Document database 138 may comprise multiple databases or may comprise a single database that stores documents of multiple types. If a document contains at least one of the terms of the search query, then the document is a candidate search result. All else being equal, if a first document contains more query terms than a second document, then the first document will be ranked higher than the second document and, therefore, is more likely to be presented on client device 110 as a search result.

### Document Ranker

Document ranker 140 ranks the documents retrieved by searcher 136. Though depicted as separate from searcher 136, the functionality of document ranker 140 may be incorporated into searcher 136. Document ranker 140 may rank the documents based on a prediction of whether a user is likely to select the document for further viewing or for retrieval. For example, if the prediction is that the user is very likely to select a first document, then the first document is ranked higher than documents whose predictions are that the user is not likely to select those documents. Other factors may be used to rank the retrieved documents, such as a level of a match and where the match occurs. For example, if the search query matches a first document more than a second document, then the first document is ranked higher, all else being equal. As another example, if the incomplete query matches a first document in a title or name portion of the first document and the incomplete query matches a second document in a lower priority portion (e.g., the body) of the second document, then the first document is ranked higher than the second document, all else being equal. Such factors may be incorporated into a machine-learned model that generates a prediction, or a probability (e.g., reflected as a value between 0 and 1), for each document, indicating a likelihood that the user will interact with (e.g., click to view or save for later viewing) the document.

### Query History Log

Each original search query, query reformulation, and query suggestion (whether user selected or not) is stored in query history log 142. Query history log 142 stores entries or records for multiple search queries. Each record may correspond to a different user and/or client device. Some records may correspond to the same user, indicating that that user initiated multiple search queries (whether an original search query, a reformulated query, or a query suggestion), whether in a single user session with content delivery system 130 or in different user sessions.

For example, a first log record or entry in query history log 142 includes an original search query that a first user entered and a query reformulation that the first user also entered, while a second log record in query history log 142 includes an original search query that a second user entered, a query suggestion that the second user selected, and two query suggestions that the second user did not select. The first log record is used to generate a sequence pair that is used to reformulation data that is used to train ML model 146, while the second log record is used to generate a sequence triple that is added to user feedback data that is also used to train ML model 146.

A user session is a group of one or more user interactions with content delivery system 130 using a computing device (e.g., client device 110), where the one or more user interactions take place within a given time frame, such as ten minutes. For example, a single session can contain multiple page views, events, social interactions, and/or search query submissions. If, while a user session is active, no user interaction is detected with content delivery system 130 after a certain period of time (e.g., five minutes), then the user session may be considered over or complete. Any future interaction by that user with content delivery system 130 will cause a new user session to commence.

### Anticipatory Search Results

In some implementations, content delivery system 130 provides one or more anticipatory search results of an auto-completed query for presentation on client device 110 in response to receiving an incomplete (or partial) query. Thus, content delivery system 130 automatically performs a search based on an auto-completed query even though a user that provided (e.g., entered) the incomplete query did not select the auto-completed query. If the user selects an anticipatory search result or otherwise provides input that indicates interest in an anticipatory search result, then query suggestion component 134 may still cause to be presented (concurrently with the anticipatory search result) one or more query suggestions that are based on the auto-completed query that is associated with the anticipatory search result.

### Rule-Based Model

Generating query suggestions may be performed in a number of ways. For example, hard-coded rules may be established that (1) identify certain attributes of the input and/or of the user that provided by the input, each input attribute and user attribute corresponding to a different score and (2) based on a combination of all the scores, determine a score for the input. However, hand crafted rule-based models have numerous disadvantages including failing to capture nonlinear correlations and the fact that the hand-selection of values (e.g., weights or coefficients) for each feature is error-prone, time consuming, and non-probabilistic. Hand-selection also allows for bias from potentially mistaken business logic. Additionally, the output of a rule-based model is typically an unbounded positive or negative value and, therefore, does not intuitively map to the selecting of relevant query terms which the model is optimizing (e.g., predicting).

### Machine-Learned Model

In an embodiment, one or more models are generated based on training data using one or more machine learning techniques. Machine learning is the study and construction of algorithms that can learn from, and make predictions on, data. Such algorithms operate by building a model from inputs in order to make data-driven predictions or decisions. Thus, a machine learning technique is used to generate a statistical model that is trained based on a history of attribute values associated with input and, optionally, users. The statistical model is trained based on multiple attributes (or factors) described herein. In machine learning parlance, such attributes are referred to as “features.” To generate and train a statistical model, a set of features is specified and a set of training data is identified.

Embodiments are not limited to any particular machine learning technique for generating or training a model. Example machine learning techniques include linear regression, logistic regression, neural networks, random forests, naive Bayes, and Support Vector Machines (SVMs). Advantages that machine-learned models have over rule-based models include the ability of machine-learned models to capture non-linear correlations between features and the reduction in bias in determining weights for different features.

Initially, the number of features that are considered for training may be significant. After training a machine-learned model and validating the model, it may be determined that a subset of the features have little correlation or impact on the final output. In other words, such features have low predictive power. Thus, machine-learned weights for such features may be relatively small, such as 0.01 or -0.001. In contrast, weights of features that have significant predictive power may have an absolute value of 0.2 or higher. Features will little predictive power may be removed from the training data. Removing such features can speed up the process of training future models and computing output scores.

### Model Trainer

Model trainer 144 trains a machine-learned model 146 using one or more machine learning techniques and based on training data that is generated based on query history log 142. Model trainer 144 (or another component of content delivery system 130) analyzes query history log 142 and generates training samples/instances for the training data. Each training instance includes a source search query and a target search query.

In an embodiment, for each space character in a training instance, that space character is replaced with a special token (e.g., “[SPACE]”). Similarly, for each unknown character in a training instance, that unknown character is replaced with another special token (e.g., “[UNK]”). Examples of unknown characters are emoticons.

Given a source search query that comprises a series or sequence of one or more query tokens or query terms (s=s₁, . . . , sₘ), ML model 146 generates or outputs one or more target search queries (t=t₁, . . . , tₙ) or “query suggestions,” each associated with a different relevance score. A goal is to find a probability function p(t|s, Θ), where Θ are model parameters, that is maximal on relevant query suggestions.

### Artificial Neural Network

An example of ML model 146 is an artificial neural network (ANN). An ANN is based on a collection of connected units or nodes, referred to as artificial neurons. Each connection allows for the transmission of a signal from one neuron to one or more neurons. A first neuron that receives a signal processes the signal and signals neurons that are connected to the first neuron. The signal received through a connection is a real number and the output of each neuron is computed by a non-linear function of the sum of its inputs. The connections are referred to as “edges.”

Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times. In addition to an input layer and an output layer, a neural network may have one or more inner or hidden layers.

An example of the final or output layer of a neural network is a softmax function. A softmax function is a generalization of the logistic function to multiple dimensions and is used in multinomial logistic regression. A softmax function is often used as the last activation function of a neural network to normalize the output of a network to a probability distribution over predicted output classes.

An input layer of an ANN takes, as input, one or more embeddings, each embedding corresponding to a term or token of a search query that a user (a) inputs into a search interface presented on client device 110 or (b) selects as a query suggestion. An embedding is a vector of real (e.g., floating point) numbers, each number corresponding to a different latent dimension. The number of latent dimensions (e.g., 64) is configurable at the pre-training stage. Initially, before training begins, each query token is assigned a random embedding, or an embedding where each number in the vector is randomly selected. Then during the training stage, for each training instance, model trainer 144 not only updates weights of one or more edges and/or one or more neurons in the ANN, but also the embeddings that correspond to the query tokens indicated in the training instance.

The training process for ANNs involves gradient descent and backpropagation. Gradient descent is an iterative optimization algorithm for finding the minimum of a function; in this case, a loss function, which is described in more detail herein. Backpropagation is a method used in ANNs to calculate the error contribution of each neuron after a batch of data is processed. In the context of learning, backpropagation is used by a gradient descent optimization algorithm to adjust the weight of neurons in an ANN by calculating the gradient of the loss function. Backpropagation is also referred to as the “backward propagation of errors” because backpropagation begins at the final (output) layer (that generates the probabilities) by calculating the error at the output and distributing that error back through the ANN layers. For models involving embeddings, there is an implicit input layer that is often not mentioned. The embeddings are actually a layer by themselves and backpropagation goes all the way back to the embedding layer. The input layer maps inputs to the embedding layer. Batch size depends on several factors, including the available memory on the computing device or GPU.

In the English language, the number of possible query tokens is relatively large, such as sixty thousand possible query tokens. Other languages have more or fewer possible query tokens. However, a user might input (e.g., type in, select, or otherwise enter) non-recognizable query tokens, such as a set of numeric characters, an emoji, or a query token with one or more unknown characters. In an embodiment, multiple query tokens map to (or are associated with) a particular embedding. For example, query tokens that include one or more numeric characters map to a first embedding, while query tokens that include emojis or unknown characters map to a second embedding. Therefore, a single embedding may represent multiple query tokens. Thus, whenever a user inputs a query token that includes one or more numeric characters, then a particular embedding is retrieved for that query token, regardless of the specific numeric character(s) in the query token.

### Examples of Artificial Neural Networks

An example of a neural network is a convolutional neural network (CNN), which is a class of deep neural networks. CNNs have applications in image and video recognition, recommender systems, image classification, medical image analysis, natural language processing, and financial time series.

CNNs are regularized versions of multilayer perceptrons. Multilayer perceptrons usually mean fully connected networks; that is, each neuron in one layer is connected to all neurons in the next layer. However, the “fully-connectedness” of these networks makes them prone to overfitting data. One way to combat overfitting is through regularization, which includes adding some form of magnitude measurement of weights to the loss function. CNNs take a different approach towards regularization. CNNs take advantage of the hierarchical pattern in data and assemble more complex patterns using smaller and simpler patterns.

CNNs use relatively little pre-processing compared to other classification algorithms. This means that a CNN learns the filters that in traditional algorithms were hand-engineered. This independence from prior knowledge and human effort in feature design is a significant benefit of CNNs.

Another example of a neural network is a recurrent neural network (RNN) where connections between neurons form a directed graph along a temporal sequence. This structure allows the neural network to exhibit temporal dynamic behavior. An RNN uses its internal state (memory) to process variable length sequences of inputs, which makes an RNN suitable for certain tasks, such as unsegmented, connected handwriting recognition and speech recognition.

### Long Short-Term Memory Network

An example of an RNN is a long short-term memory (LSTM) network. LSTM networks are well-suited to classifying, processing, and making predictions based on time series data because there may be lags of unknown duration between important events in a time series. LSTM networks were developed to deal with the vanishing gradient problem that can be encountered when training traditional RNNs. Relative insensitivity to gap length is one advantage of LSTM over RNNs, hidden Markov models, and other sequence learning methods in numerous applications.

An LSTM network includes an LSTM portion and, optionally, a non-LSTM portion that takes, as input, output from the LSTM portion and generates an output (e.g., a classification) of its own. The LSTM portion includes multiple LSTM units. Each LSTM unit in an LSTM network may be identical in structure to every other LSTM unit in the LSTM network.

A LSTM unit may be composed of a cell, an input gate, an output gate, and a forget gate. Some variations of the LSTM unit do not have one or more of these gates or may have other gates. The cell “remembers” values over arbitrary time intervals and the three gates regulate the flow of information into and out of the cell. An advantage of an LSTM cell compared to a common recurrent unit is its cell memory unit. The cell vector has the ability to encapsulate the notion of “forgetting” part of its previously stored memory, as well as to add part of the new information. To illustrate this, one must inspect the equations of the cell and the way the cell processes sequences of data.

Intuitively, the cell is responsible for keeping track of the dependencies between the elements in an input sequence. The input gate controls the extent to which a new value flows into the cell, the forget gate controls the extent to which a value remains in the cell, and the output gate controls the extent to which the value in the cell is used to compute the output activation of the LSTM unit. The activation function of the LSTM gates may be a logistic sigmoid function. The activation function of each LSTM gate may be different. There are connections into and out of the LSTM gates, a few of which are recurrent. The weights of these connections, which are learned during training, determine how the gates operate. If the number of gates in an LSTM unit is four and there are 64 elements or data values in an embedding, then an LSTM unit may have 4*(hidden_size*(input+output)+bias)=4*(64*(64+64)+64)=33,024 weights that are learned during training.

### Query Suggestion Component

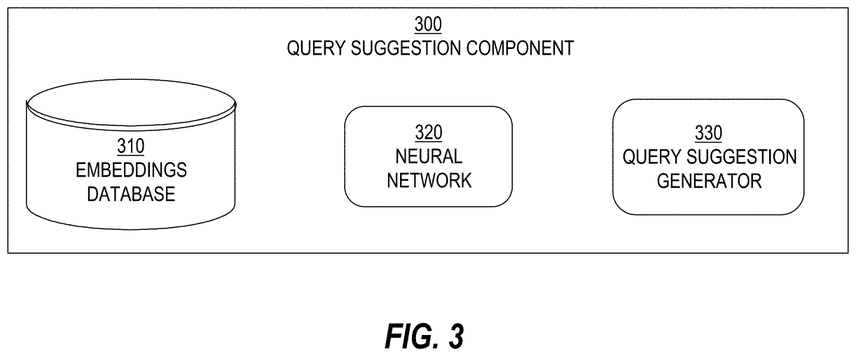

FIG. 3 is a block diagram that depicts an example query suggestion component 300 that corresponds to query suggestion component 134 of FIG. 1, in an embodiment. Query suggestion component 300 includes an embeddings database 310, a neural network 320, and a query suggestion generator 330. Embeddings database 310 stores embeddings that were learned (or generated by model trainer 144) while training neural network 320 based on training data that was generated from query history log 142, such as reformulation data and user feedback data.

Query suggestion component 300 receives an input search query, for example, from client device 110. The input search query may be received in a request that also includes an indication that the input search query is complete, or that the user that formed or selected the search query was done forming the search query. The input search query comprises one or more query terms or tokens. In response to receiving the search query, query suggestion component 300 retrieves, from embeddings database 310, an embedding for each token in the input search query. Thus, if the input search query includes three tokens, then three embeddings are retrieved from embeddings database 310.

Each entry or record in embeddings database 310 may store an association (directly or indirectly) between a query token and an embedding. For example, query suggestion component 300 retrieves a query token identifier for a query token in an input search query and then uses the query token identifier to lookup the corresponding embedding in embeddings database 310.

Query suggestion component 300 inputs the retrieved embeddings into neural network 320, which has been trained using one or more machine learning techniques. Inputting an embedding into neural network 320 involves, for a particular neuron in the input layer, for each data value or number in the embedding, applying a learned weight to that data value (e.g., multiplying the data value by a weight), where the learned weight corresponds to a position in the embedding occupied by the data value. If an embedding has one hundred data values, then there are one hundred learned weights. Then, the results of applying each data value to a corresponding weight are combined (by the particular neuron) to produce an output. The operation may be v1*w1+v2*w2+v3*w3+v100*w100, where v is the value, and w is the weight. If there are multiple input neurons, then this process repeats for each of those input neurons; however, the weights that have been learned for each embedding position is likely to be different than the weights learned for other input neurons.

Neural network 320 produces or outputs multiple values, each reflecting a probability that the query token that corresponds to that value is the next output query token is a target sequence, given the input search query. In other words, the output of neural network reflects multiple predictions, one for each of multiple words or token in a vocabulary. For example, one output value indicates a first probability that the corresponding query token should be the next output query token, while another output value indicates a second probability that the corresponding query token should be the next query token. If there are sixty thousand words in the vocabulary, then neural network 320 produces sixty thousand values or probabilities for each output query token. One of the possible output query tokens may be an end-of-sequence token, indicating that there should be no more output query tokens. Thus, if the probability associated with the end-of sequence token is the highest (or among the highest) in an output, then query suggestion component 300 may determine to stop adding query tokens to the target output sequence (or query suggestion).

Query suggestion generator 330 generates one or more query suggestions based on the output from neural network 320. For example, query suggestion generator 330 selects the top P values (or values that exceed a particular threshold) from the first output to begin generating P target sequences. Each query token corresponding to a value in the top N values is used as the first query token in a target sequence. Query suggestion generator 330 retrieves an embedding for each of those query tokens. For each retrieved embedding, query suggestion generator 330 inputs that embedding to neural network 320 to generate second output. Query suggestion generator 330 selects the top M values (or values that exceed a particular threshold) from the second output and adds the query tokens from those M values to target sequence corresponding to the retrieved embedding. The process may repeat until an end-of-sequence token is determined for each target sequence or some other rule(s) is/are satisfied, such as a target sequence cannot be more than three query tokens longer than the input search query.

### Sequence-to-Sequence Modeling

In an embodiment, neural network 320 functions as a sequence-to-sequence (Seq2Seq) model, which maps a fixed-length input to a fixed-length output where the length of the input and output may differ. Seq2Seq models produce a target sequence t of any length from a source sequence s. In multiple examples herein, the source sequence is an original (or input) search query and the target sequence is a query suggestion in the same language as the original search query. Seq2Seq models include an encoder and a decoder.

Both the encoder and the decoder may comprise LSTM units or GRU units. The encoder reads an input sequence and summarizes the information in “internal state vectors” or a “context vector.” In the case of LSTM units, such information is summarized in “the hidden state” and “cell state vectors.” Outputs of the encoder are discarded and the internal states are preserved. The context vector aims to encapsulate the information for all input elements in order to help the decoder make accurate predictions. The hidden states hᵢ are computed using the formula:

hₜ′=f(W^{(hh)}h₋₁+W^{(hx)}xₜ)

where xₜ is an input embedding that corresponds to token t in the input sequence, W^{(hh)} are the weights applied to the previous hidden state, and W^{(hx)} are the weights applied to the input embeddings.

The LSTM portion of the encoder reads the data, one token in the input sequence after the other. Thus, if the input sequence has length t, then the LSTM portion reads the input sequence in ‘t’ time steps. Thus, xᵢ is the input sequence at time step i, and hᵢ and cᵢ are two states (‘h’ for hidden state and ‘c’ for cell state) that the LSTM portion maintains at each time step. Together, hᵢ and cᵢ are the internal state of the LSTM portion at time step i.

The decoder may be multiple LSTM units whose initial states are initialized to the final states of the LSTM portion of the encoder, i.e. the context vector of the encoder's final cell is input to the first cell of the decoder network. Using these initial states, the decoder starts generating the output sequence, and these outputs are also taken into consideration for future outputs.

The decoder may comprise a stack of several LSTM units where each LSTM unit predicts an output yₜ at a time step t. Each recurrent unit in the decoder accepts a hidden state from the previous unit and produces an output as well as its own hidden state. Any hidden state hᵢ may be computed using the formula:

hₜ=f(W^{(hh)}hₜ₋₁)

The output yₜ at time step t may be computed using the formula:

yₜ=softmax(W^{S}hₜ)

The outputs are calculated using the hidden state at the current time step together with the respective weight W(S). Softmax may be used to create a probability vector that is used to determine the final output, such as a query suggestion.

During inference or when the Seq2Seq model is invoked and a sequence is input to the model, one token (e.g., word) is output at a time. The initial states of the decoder may be set to the final states of the encoder. The initial input to the decoder may be a START token. At each time step, the states of the decoder are preserved and are set as the initial states for the next time step. At each time step, the predicted output is inputted into the next time step. The loop ceases or is broken when the decoder predicts an END token.

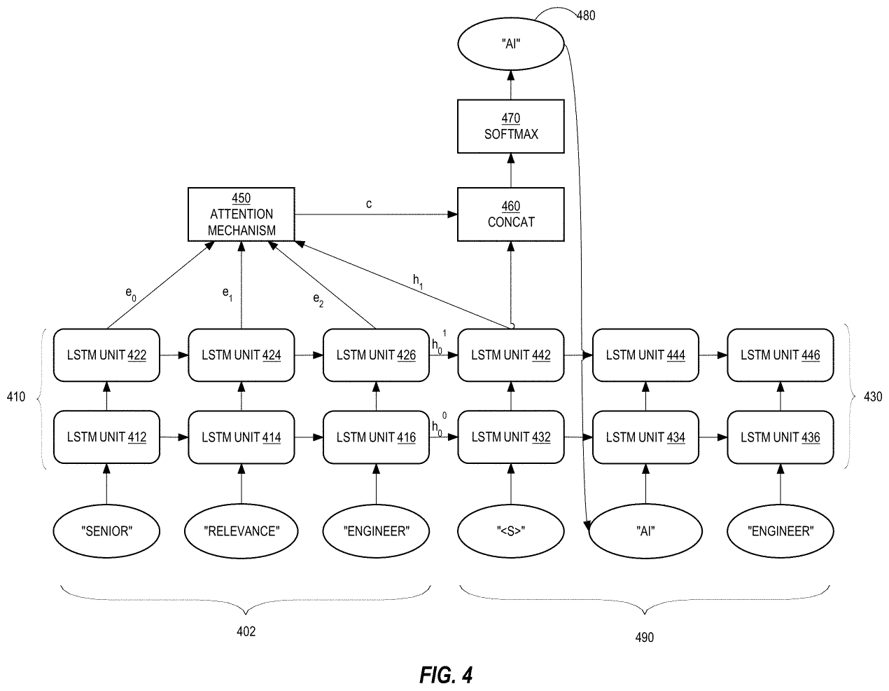

FIG. 4 is a block diagram that depicts an example Seq2Seq model 400, in an embodiment. Model 400 a two-layer encoder 410 that comprises LSTM units 412-426, a two-layer decoder 430 that comprises LSTM units 432-446, an attention component 450, a concatenator 460, and a softmax layer 480. Model 400 may comprise a different architecture than what is depicted in FIG. 4 and described herein. For example, model 400 may instead comprise a single layer encoder and a single layer decoder. Also, model may comprise more than three LSTM units in each layer of encoder 410 and in each layer of decoder 430. Model 400 also comprises an input layer that is not depicted, but accepts, as input, embeddings for input sequence 402. In this example, input sequence 402 comprises three tokens, but other input sequences may contain more or fewer tokens.

Two-layer encoder 410 takes, as input, an input sequence and produces a fixed dimensional vector h₀ and a vector for each input query token, collectively denoted e. Each LSTM unit in two-layer decoder 430 is a function that is intended to represent the i^{th} target query token, given all previous target query tokens, and the entire source search query, using an intermediate hidden state hᵢ:

p(Tᵢ₋₁, . . . , t₀,s₀,s₁, . . . , sₘ):=p(tᵢ|hᵢ₋₁,e;Θ)

Decoder 430 is coupled with a softmax layer on each hᵢ with attention mechanism 450. If N is the number of words in the target sequence (or query suggestion) t, then the log probability of an entire sequence is the sum over log probabilities for each token in the target sequence:

log p(t|s)=Σ^{N} log p_{w}(tᵢ|tᵢ₋₁, . . . , t₀; s)

In the example of FIG. 4, the first output query token in output sequence 490 is a start token (“<S>”). The output of attention mechanism 450 (‘c’) and the output of LSTM unit 442 is input to concatenator 460, which concatenates the respective vectors to generate a concatenated vector. The concatenated vector is input to softmax 470, which generates an output that comprises a probability distribution over the entire vocabulary. Thus, each output that softmax 470 generates is a vector whose size is the size of the vocabulary, which vector represents the probability distribution. In this example, the query token that is selected as the most probable next token in output sequence 490 after the start token is “AI.”

Output sequence 490 also includes an output token of “engineer”, which would be based on the concatenation (of (1) vector ‘c’ with (2) the output of LSTM unit 444), which is input to softmax 470, which generates another probability distribution. Because the token “engineer” may be associated with the highest probability in the probability distribution, then that token is selected as the next query token for output sequence 490. Although not depicted in FIG. 4, the next query token that is selected based on the next output of softmax 470 may be an end token. Thus, the query suggestion based on “senior relevance engineer” would be “AI engineer.”

### Transformers

In the example of model 400, the encoder and the decoder comprise LSTM units, which are a type of RNN units. Alternatively, the encoder and the decoder may be transformers. A transformer is a deep learning model used primarily in the field of natural language processing (NLP). Like RNNs, transformers are designed to handle sequential data, such as natural language, for tasks such as translation and text summarization. However, unlike RNNs, transformers do not require that the sequential data be processed in order. For example, if the input data is a natural language sentence, the transformer does not need to process the beginning of it before the end. Due to this feature, the transformer allows for more parallelization than RNNs and therefore reduced training times.

Before the introduction of transformers, many NLP systems relied on gated (RNNs), such as LSTMs and gated recurrent units (GRUs), with added attention mechanisms. The transformer built on these attention technologies without using an RNN structure, highlighting the fact that the attention mechanisms alone, without recurrent sequential processing, are powerful enough to achieve the performance of RNNs with attention.

Gated RNNs process tokens sequentially, maintaining a state vector that contains a representation of the data seen after every token. To process the nth token, the model combines the state representing the sentence up to token n−1 with the information of the new token to create a new state, representing the sentence up to token n. Theoretically, the information from one token can propagate arbitrarily far down the sequence, if at every point the state continues to encode information about the token. But in practice this mechanism is imperfect: due in part to the vanishing gradient problem, the model's state at the end of a long sentence often does not contain precise, extractable information about early tokens.

This problem was addressed by the introduction of attention mechanisms. Attention mechanisms let a model directly look at, and draw from, the state at any earlier point in the sentence. The attention layer can access all previous states and weighs them according to some learned measure of relevancy to the current token, providing sharper information about far-away relevant tokens.

When added to RNNs, attention mechanisms led to large gains in performance. The introduction of the Transformer brought to light the fact that attention mechanisms were powerful in themselves, and that sequential recurrent processing of data was not necessary for achieving the performance gains of RNNs with attention. The Transformer uses an attention mechanism without being an RNN, processing all tokens at the same time and calculating attention weights between them. The fact that Transformers do not rely on sequential processing and lend themselves very easily to parallelization allows transformers to be trained more efficiently on larger datasets.

### Loss Function

Machine learning is strongly related to optimization since many learning problems are formulated as a minimization of some loss function on a training set. Loss functions express the discrepancy between (1) the predictions of a model being trained and (2) the actual problem instances. The difference between machine learning and optimization arises from the goal of generalization: while optimization algorithms minimize the loss on a training set, machine learning is concerned with minimizing the loss on unseen samples.

In the context of an optimization algorithm, the function used to evaluate a candidate solution (i.e. a set of weights) is referred to as the objective function. A goal is to maximize or minimize the objective function, meaning that there is a search for a candidate solution that has the highest or lowest score, respectively.

Typically, with neural networks, a goal is to minimize the error. As such, the objective function is often referred to as a cost function or a loss function and the value calculated by the loss function is referred to as “loss.” In calculating the error of the model during the optimization process, a loss function must be chosen. Choosing a loss function can be a challenging problem as the function should capture the properties of the problem and be motivated by concerns that are important to the project that will incorporate the model.

The choice of loss function may be related to the activation function used in the output layer of the neural network. The configuration of the output layer may be thought of as a choice about the framing of the prediction problem, and the choice of the loss function may be thought of as the way to calculate the error for a given framing of the problem.

For example, in regression problems where a real-value quantity is being predicted and the output layer configuration is a single node with a linear activation unit, then the loss function is Mean Squared Error (MSE).

As another example, in problems (a) where an example is classified as belonging to one of more than two classes (e.g., in machine translation problems) and (b) may be framed as predicting the likelihood of an example belonging to each class, and where the output layer configuration is a single node for each class using a softmax activation function, then the loss function is a logarithmic loss (or cross-entropy loss, or log loss).

An example of a loss function for a Seq2Seq model is the following log loss function:

L=Σ−log p(t|s) (1)

where L is the loss, p(t|s) is the probability of a target sequence (or query suggestion) t given a source sequence (or original search query) s, and Σ is a summation over all source-target sequence pairs in a reformulation data set.

### Modifying the Loss Function

In an embodiment, the loss function of a Seq2Seq model is a logarithm loss function (or log loss function) with multiple terms, at least one of which takes into account user feedback data, in an embodiment. An example of such a log loss function is the following:

L=Σ−log p(t|s)+λ* Σ max(0, log p(tₙ|s_{f})−log p(tₙ|s_{f})+ϵ) (2)

where the first Σ is a summation over multiple (e.g., all) source-target sequence pairs in the reformulation data set (as in equation (1)) and the second Σ is a summation over multiple (e.g., all) sequence triples in the user feedback data set, where s_{f} is a source (or original) search query in one of the sequence triples, tₚ is a query suggestion (in the same sequence triple as s_{f}) that the user who provided s_{f} selected/clicked (or positive example), and tₙ is a query suggestion (in the same sequence triple as s_{f}) that the user who provided s_{f} did not select/click (or negative example). The s from the reformulation data and the s_{f} from the user feedback data do not need to match.

The second term (from the first addition (+) operator to the last parathesis) in equation (2) comprises three parts: (a) a max switch that can disable the penalty (i.e., log p(tₙ|s_{f})−log p(tₚ|s_{f})+ϵ) if the positive example (tₚ) is already better than the negative example (tₙ); (b) lambda (λ) is a relative weight that controls the contribution of the reformulation data versus the user feedback data to the loss; and (c) epsilon (ϵ) is a margin parameter that determines how much “slack” is allowed before the penalty occurs.

The term ϵ has different effects whether it is positive or negative. The penalty is active if log p(tₙ|s_{f})−log p(tₚ|s_{f})+ϵ>0; thus, there is no penalty if log p(tₙ|s_{f})−log p(tₚ|s_{f})+ϵ<=0. If ϵ>0, then there is no penalty if log p(tₙ|s_{f})+ϵ<=log p(tₚ|s_{f}). This forces log p(tₙ|s_{f}) to not only be less than log p(tₚ|s_{f}), but ϵ less than that, in order to not incur a penalty. This enforces a minimum separation. On the other hand, if ϵ<0, then there is no penalty if log p(tₙ|s_{f})<=log p(tₚ51 s_{f})+(−ϵ). This allows violation of log p(tₙ|s_{f})<=log p(tₚ|s_{f}) up to ϵ, so the requirement is not as strict.

Thus, the loss function in equation (2) calculates the total cross entropy between an expectation and a prediction, plus a weighted penalty that is proportional to how much a negative example (tₙ) outperforms a positive example (tₚ). If the positive example outscores the negative example by at least a certain margin ϵ, then no penalty is incurred.

In other embodiments, a strict subset of these three parts are included in the loss function. For example, in one embodiment, the relative weight (λ) is missing from equation (2), while in another embodiment, the max switch and the margin parameter (ϵ) are missing from equation (2). Thus, the following example equations are variations of equation (2) that also take into account reformulation data and user feedback data in the same loss function:

L=Σ−log p(t|s)+λ*Σ max(0, log p(tₙ|s_{f})−log p(tₚ|s_{f})) (3)

L=Σ−log p(t|s)+λ*Σ log p(tₙ|s_{f})−log p(tₚ|s_{f}) (4)

L=Σ−log p(t|s)+Σ log p(tₙ|s_{f})−log p(tₚ|s_{f}) (5)

L=Σ−log p(t|s)+Σ max(0, log p(tₙ|s_{f})−log p(tₚ|s_{f})+ϵ) (6)

L=Σ−log p(t|s)+Σ log p(tₙ|s_{f})−log p(tₚ|s_{f})+ϵ (7)

L=Σ−log p(t|s)+Σ max(0, log p(tₙ|s_{f})−log p(tₚ|s_{f})) (8)

### Hyperparameters

Training a Seq2Seq model using one or more machine learning techniques or algorithms involves defining one or more hyperparameters. A hyperparameter is a parameter whose value is used to control the machine learning process. By contrast, the values of other parameters (e.g., node weights) are derived via training. Examples of hyperparameters include topology and size of an ANN, batch size, and epoch. Batch size controls the number of training samples to work through before the model's internal parameters are updated. The number of epochs is a hyperparameter of gradient descent that controls the number of complete passes through the training dataset. An epoch comprises one or more batches.

In an embodiment, the smaller of the two training data sets (i.e., the reformulation data set and the user feedback data set) is oversampled so that the two training data sets are lined up for each epoch.

### Data Augmentation

The loss function in equation (2) allows the user feedback data to be augmented with negative samples. If it is known that the Seq2Seq model wrongly promotes certain “bad” query suggestions, such as ungrammatical, fragmented, or repetitive query suggestions, then such negative query suggestions may be inserted in the user feedback data as negative examples to teach the Seq2Seq model to avoid these patterns.

To generate negative examples, the following algorithm may be implemented: for a given source or original search query, a “bad” query suggestion is generated by appending, to the source query, one of the following at random: (1) a random word from the source (e.g. “remote software engineer” becomes “remote software engineer remote”); (2) a random joiner word from ‘and’, ‘in’, ‘the’, ‘of’, ‘or’ (e.g., “software engineer” becomes “software engineer in”); (3) a random joiner plus a word from the source (e.g., “software engineer” becomes “software engineer and software”. Thus, for each sequence triple {s_{f}, tₚ, tₙ} in the user feedback data, another sequence triple {s_{f}, tₚ, t_{bad}} (where t_{bad} is automatically generated “bad” query suggestion) is added to the user feedback data with probability p_{bad}. This data augmentation technique is merely one possible way of creating negative samples.

### Experiments

Experiments have shown that the Seq2Seq model described herein (i.e., that includes a loss function with one term for reformulation data and another term for user feedback data) performs better than past approaches for implementing Seq2Seq models on at least two measures of quality: perplexity and mean reciprocal rank (MRR). Perplexity is a standard measurement of the amount of “surprise” per word. A high perplexity means that the model's output generally reflects that there are many roughly equally plausible query suggestions to choose from. The lower a model's perplexity, the better.

MRR is evaluated by computing the model probability score on each of k (e.g., k=six) query suggestions for a given source query. The query suggestions are ranked from high probability to low probability and the rank of the user-selected query suggestion is identified. The final score is the average of 1/rank. This measurement correlates with assigning higher scores to user-selection query suggestions rather than non-selected query suggestions. A low perplexity model may cluster several “bad” query suggestions as highly as the selected query suggestion, but a high MRR model is less likely to make this mistake.

### Deployment of a Sequence-to-Sequence Model

In an embodiment, a Seq2Seq model (that is trained using a loss function that accounts for both reformulation data and user feedback data) is invoked to provide real-time results in response to an original search query from a computing device, such as client device 110. A real-time result is a set of query suggestions that is determined and sent to the computing device for display in less than three seconds from receiving the original search query; many times in less than one second.

In an embodiment, the query suggestion component and the document retrieval and ranking component are called in parallel so that results from both may be presented on a computing device near simultaneously or concurrently.

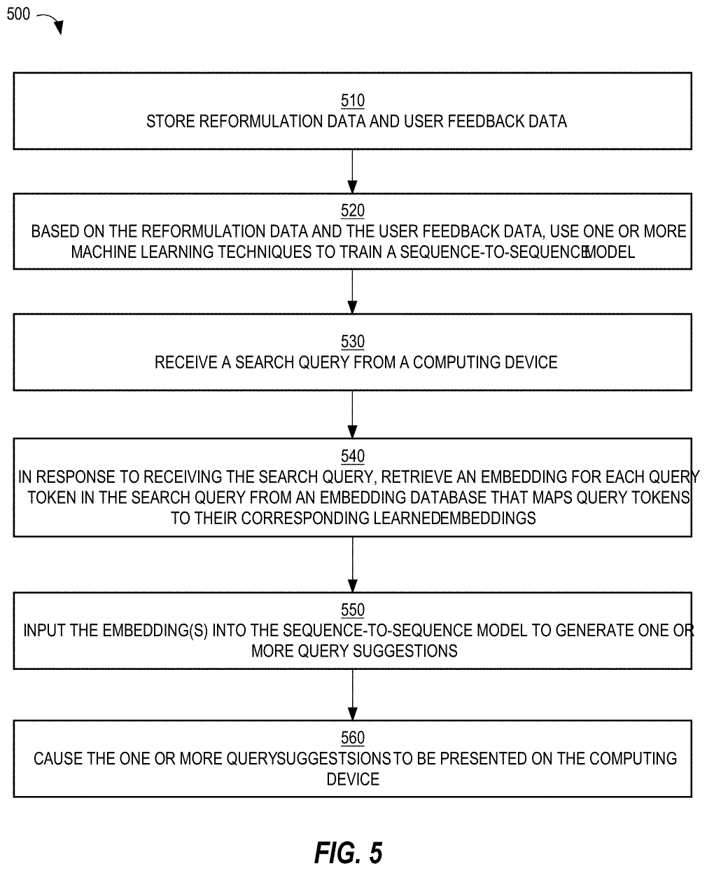

FIG. 5 is a flow diagram that depicts an example process 500 for generating query suggestions using a sequence-to-sequence model, in an embodiment. Process 500 may be performed by different components of content delivery system 130, such as model trainer 144 and query suggestion component 134.

At block 510, reformulation data and user feedback data are stored. The reformulation data may be generated by analyzing query history log 142 to identify logs that indicate that a user submitted a search query, was presented results of the search query, modified the search query, and submitted the modified search query, whether or not the user selected one of the results of the search query. Each entry in the reformulation data includes a pair of sequences, the first sequence in the pair being the original search query submitted by a user and the second sequence in the pair being the modified or reformulated search query submitted the by the user.

Similarly, the user feedback data may be generated by analyzing query history log 142 to identify logs that indicate a user submitted a search query, was presented query suggestions, and selected (e.g., clicked) one of the query suggestions. Each entry in the user feedback data includes a triple (or set) of (three) sequences: the first sequence in the triple being the original search query submitted by a user, the second sequence in the triple being the query suggestion selected by the user, and the third sequence in the triple being a query suggestion that the user did not select.

At block 520, based on the reformulation data and the user feedback data, using one or more machine learning techniques are used to train a sequence-to-sequence model. Block 520 may be performed by model trainer 320. Training the sequence-to-sequence model involves using a loss function that comprises (1) a first term that takes, as input, sequence pairs from the reformulation data and (2) a second term that takes, as input, sequence triples from the user feedback data. Block 520 also results in generating or training a set of query token embeddings for different query terms/tokens in a vocabulary.

At block 530, a search query is received from a computing device. For example, the search query may be received from client device 110 over network 120 through query interface 132.

At block 540, in response to receiving the search query, an embedding for each query token/term in the search query is retrieved from an embedding database that maps query tokens to their corresponding learned embeddings. Block 540 may involve identifying multiple tokens in the search query based on one or more characters, such as a space, comma, or period that delineates two query tokens.

At block 550, the embedding(s) is/are input into the sequence-to-sequence model to generate one or more query suggestions. Block 540 may be performed by query suggestion generator 330.

At block 560, the one or more query suggestions are caused to be presented on the computing device. Block 560 may involve content delivery system 120 transmitting the one or more query suggestions over network 120 to client device 110. Block 560 may also involve content delivery system 120 also transmitting one or more results of a search (performed by searcher 136) that is based on the original search query. In this way, the one or more query suggestions may be presented concurrently with the one or more search results.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

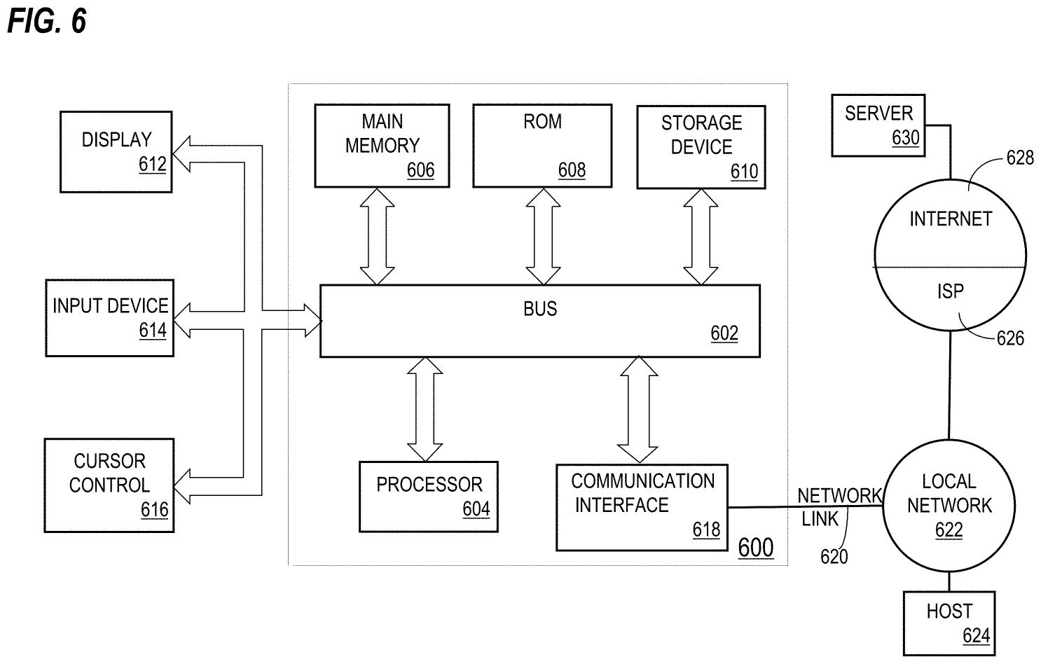

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing reformulation data that comprises a plurality of sequence pairs;
storing feedback data that comprises a plurality of sequence triples;
based on the reformulation data and the feedback data, training, using one or more machine learning techniques, a sequence-to-sequence model;
wherein training the sequence-to-sequence model comprises using a loss function that comprises (1) a first term that takes, as input, sequence pairs from the reformulation data and (2) a second term that takes, as input, sequence triples from the feedback data;
after training the sequence-to-sequence, receiving a search query from a computing device;
in response to receiving the search query:
retrieving a set of embeddings, each corresponding to a token in the search query;
inputting the set of embeddings into the sequence-to-sequence model to generate one or more query suggestions;
causing the one or more query suggestions to be presented on the computing device;
wherein the method is performed by one or more computing devices.

2. The method of claim 1, wherein the second term includes a max switch that disables the contribution of the second term to the loss function for positive relative differences between negative examples and positive examples in the feedback data.

3. The method of claim 1, wherein the second term is multiplied by a relative weight that controls the relative contribution, to the output of the loss function, of a training sample from the reformulation data to a training sample from the feedback data.

4. The method of claim 1, wherein the second term includes a margin parameter that determines an amount of slack that is allowed before a penalty from the second term is incurred.

5. The method of claim 1, further comprising, prior to storing a portion of the reformulation data:
receiving a first search query from a first computing device;
in response to receiving the first search query, determining a first set of search results and causing the first set of search results to be presented on the first computing device;
after causing the first set of search results to be presented on the first computing device, receiving a second search query, from the first computing device, that is different than the first search query;
in response to receiving the second search query, generating an association between the first search query and the second search query and storing the association in the reformulation data.

6. The method of claim 1, further comprising, prior to storing a portion of the feedback data:
receiving a first search query from a first computing device;
in response to receiving the first search query:
determining a plurality of query suggestions that includes a first query suggestion and a second query suggestion;
causing the plurality of query suggestions to be presented on the first computing device;
after causing the plurality of query suggestions to be presented on the first computing device, receiving, from the first computing device, input that indicates a selection of the first query suggestion of the plurality of query suggestions;
in response to receiving the input:
generating an association between the first search query, the first query suggestion as a positive example, and the second query suggestion as a negative example;
storing the association in the feedback data.

7. The method of claim 1, wherein the sequence-to-sequence model comprises (1) an encoder comprising a first plurality recurrent units; (2) a decoder comprising a second plurality of recurrent units, (3) a softmax layer that outputs a vector that has a size of a number of words in a vocabulary and that represents a probability distribution over the vocabulary.

8. The method of claim 7, wherein:
inputting the set of embeddings into the sequence-to-sequence model comprises inputting each embedding of the set of embeddings into a different recurrent unit of the first plurality of recurrent units;
the method further comprising:
generating, for the softmax layer, first input that is based on output from each of the first plurality of recurrent units and first output from a first recurrent unit of the second plurality of recurrent units;
generating, by the softmax layer, based on the first input, a first probability distribution;
selecting a first output token based on the first probability distribution;
generating, for the softmax layer, second input that is based on the output from each of the first plurality of recurrent units and second output, from a second recurrent unit of the second plurality of recurrent units, that is generated based on the first output token;
based on the second input, generating, by the softmax layer, a second probability distribution;
selecting a second output token based on the second probability distribution.

9. One or more storage media storing instructions which, when executed by the one or more processors, cause:
storing reformulation data that comprises a plurality of sequence pairs;
storing feedback data that comprises a plurality of sequence triples;
based on the reformulation data and the feedback data, training, using one or more machine learning techniques, a sequence-to-sequence model;
wherein training the sequence-to-sequence model comprises using a loss function that comprises (1) a first term that takes, as input, sequence pairs from the reformulation data and (2) a second term that takes, as input, sequence triples from the feedback data;
after training the sequence-to-sequence, receiving a search query from a computing device;
in response to receiving the search query:
retrieving a set of embeddings, each corresponding to a token in the search query;
inputting the set of embeddings into the sequence-to-sequence model to generate one or more query suggestions;
causing the one or more query suggestions to be presented on the computing device.

10. The one or more storage media of claim 9, wherein the second term includes a max switch that disables the contribution of the second term to the loss function for positive relative differences between negative examples and positive examples in the feedback data.

11. The one or more storage media of claim 9, wherein the second term is multiplied by a relative weight that controls the relative contribution, to the output of the loss function, of a training sample from the reformulation data to a training sample from the feedback data.

12. The one or more storage media of claim 9, wherein the second term includes a margin parameter that determines an amount of slack that is allowed before a penalty from the second term is incurred.

13. The one or more storage media of claim 9, wherein the instructions, when executed by the one or more processors, further cause, prior to storing a portion of the reformulation data:
receiving a first search query from a first computing device;
in response to receiving the first search query, determining a first set of search results and causing the first set of search results to be presented on the first computing device;
after causing the first set of search results to be presented on the first computing device, receiving a second search query, from the first computing device, that is different than the first search query;
in response to receiving the second search query, generating an association between the first search query and the second search query and storing the association in the reformulation data.

14. The one or more storage media of claim 9, wherein the instructions, when executed by the one or more processors, further cause, prior to storing a portion of the feedback data:
receiving a first search query from a first computing device;
in response to receiving the first search query:
determining a plurality of query suggestions that includes a first query suggestion and a second query suggestion;
causing the plurality of query suggestions to be presented on the first computing device;
after causing the plurality of query suggestions to be presented on the first computing device, receiving, from the first computing device, input that indicates a selection of the first query suggestion of the plurality of query suggestions;
in response to receiving the input:
generating an association between the first search query, the first query suggestion as a positive example, and the second query suggestion as a negative example;
storing the association in the feedback data.

15. The one or more storage media of claim 9, wherein the sequence-to-sequence model comprises (1) an encoder comprising a first plurality recurrent units; (2) a decoder comprising a second plurality of recurrent units, (3) a softmax layer that outputs a vector that has a size of a number of words in a vocabulary and that represents a probability distribution over the vocabulary.

16. The one or more storage media of claim 15, wherein:
inputting the set of embeddings into the sequence-to-sequence model comprises inputting each embedding of the set of embeddings into a different recurrent unit of the first plurality of recurrent units;
the instructions, when executed by the one or more processors, further cause:
generating, for the softmax layer, first input that is based on output from each of the first plurality of recurrent units and first output from a first recurrent unit of the second plurality of recurrent units;
generating, by the softmax layer, based on the first input, a first probability distribution;
selecting a first output token based on the first probability distribution;
generating, for the softmax layer, second input that is based on the output from each of the first plurality of recurrent units and second output, from a second recurrent unit of the second plurality of recurrent units, that is generated based on the first output token;
based on the second input, generating, by the softmax layer, a second probability distribution;
selecting a second output token based on the second probability distribution.

17. A system comprising:
one or more processors;
one or more storage media storing instructions which, when executed by the one or more processors, cause:
storing reformulation data that comprises a plurality of sequence pairs;
storing feedback data that comprises a plurality of sequence triples;
based on the reformulation data and the feedback data, training, using one or more machine learning techniques, a sequence-to-sequence model;
wherein training the sequence-to-sequence model comprises using a loss function that comprises (1) a first term that takes, as input, sequence pairs from the reformulation data and (2) a second term that takes, as input, sequence triples from the feedback data;
after training the sequence-to-sequence, receiving a search query from a computing device;
in response to receiving the search query:
retrieving a set of embeddings, each corresponding to a token in the search query;
inputting the set of embeddings into the sequence-to-sequence model to generate one or more query suggestions;
causing the one or more query suggestions to be presented on the computing device.

18. The system of claim 17, wherein the second term includes a max switch that disables the contribution of the second term to the loss function for positive relative differences between negative examples and positive examples in the feedback data.

19. The system of claim 17, wherein the second term is multiplied by a relative weight that controls the relative contribution, to the output of the loss function, of a training sample from the reformulation data to a training sample from the feedback data.

20. The system of claim 17, wherein the second term includes a margin parameter that determines an amount of slack that is allowed before a penalty from the second term is incurred.
